(19) United States
(12) Patent Application Publication
(10) Pub. No.: US 2025/0131382 A1
(43) Pub. Date: Apr. 24, 2025

(54) MACHINE LEARNING-BASED RECRUITING SYSTEM

(71) Applicant: ProsperCare LLC, Atlanta, GA (US)

(72) Inventor: Todd D. Williams, Atlanta, GA (US)

(21) Appl. No.: 18/722,222

(22) PCT Filed: Dec. 22, 2022
(86) PCT No.: PCT/US2022/082205

§ 371 Date: Jun. 20, 2024

Related U.S. Application Data
(60) Provisional application No. 63/293,571, filed on Dec. 23, 2021.

(51) Int. Cl. G06Q 10/1053; G06Q 10/0631

(52) U.S. Cl. CPC G06Q 10/1053; G06Q 10/063112

(57) ABSTRACT

A system for intelligent AI-based optimization of processing of job applicants. The system includes a processor of a recruitment server connected to an applicant data provider node over a network and a memory on which are stored machine-readable instructions that when executed by the processor, cause the processor to: receive data related to an applicant for a position from the applicant's data provider node; parse the data by a skill filter to derive a plurality of matching features; provide the plurality of the matching features to a machine learning (ML) module; receive a recommendation from the ML module pertaining to interviewing the applicant; responsive to a receipt of a positive recommendation, access live interview data; derive a feature vector from the live interview data; pass the feature vector to the ML module; and receive predictive outputs from the ML module indicating a degree to which the applicant fits the position.

### RELATED APPLICATIONS

The present application is a U.S. National Stage under 35 U.S.C. § 371 of International Application No. PCT/US22/82205 filed on Dec. 22, 2022, which claims the benefit under 35 U.S.C. § 119 (e) of U.S. Provisional Application No. 63/293,571 filed on Dec. 23, 2021, which are incorporated by reference herein in its entirety.

It is intended that the above-referenced application may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to recruitment and hiring of job candidates and more particularly, to an intelligent machine learning (ML)-based and artificial intelligence (AI)-enhanced automated system for job applicants' selection and interview processing optimization.

### BACKGROUND

Hiring systems are conventionally implemented in two stages: Applicant Tracking System (ATS) that is used to manage the flow of applicants for a given position and HR System (HRS) that is used to convert the applicant to a hired employee. The ATS is simply a “funnel management” tool that tracks applicant's movement from an initial application through manual pre-screening of a resume for matching requirements of the position. The ATS may message the applicant for an interview, schedule the interview and arrange logistics for the in-person, over the phone or virtual interview. The ATS may manually note results of the interview (offer/next steps/pass) and may advance to onboarding and hiring logistics (e.g., background check, drug screening, etc.).

Subsequently, the HRS may be used to advance the new employee through the new hire process to begin work. Variety of integrations for the ATS and HRS are offered across various platforms. However, while the conventional ATS and HRS systems are software-based, they fall short in dealing with the logistical challenges. The conventional hiring solutions do not provide for automated optimized matching of an applicant at the position-level. The conventional solutions only process data, but do not provide any intelligent means for determining if applicant's experience and credentials fit the position. Typically, the determination is performed manually by an HR recruiter. The conventional systems do not provide for live video analytics of the interview process to optimize the selection and hiring of applicants.

Accordingly, an intelligent machine learning (ML)-based automated system for selection and AI-enhanced optimization of processing of job applicants is desired.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

One embodiment of the present disclosure provides a system for an intelligent machine learning (ML)-based automated selection and artificial intelligence (AI) enhanced optimization of processing of job applicants. The system includes a processor of a recruitment server connected to at least one applicant data provider node over a network and a memory on which are stored machine-readable instructions that when executed by the processor, cause the processor to: receive data related to an applicant for a position from the applicant's data provider node; parse the data by a skill filter to derive a plurality of matching features; provide the plurality of the matching features to a machine learning (ML) module; receive a recommendation from the ML pertaining to interviewing the applicant; responsive to a receipt of a positive recommendation, access live interview data; derive a feature vector from the live interview data; pass the feature vector to the ML module for generating a predictive model; and receive predictive outputs from the ML module indicating a degree to which the applicant fits the position.

Another embodiment of the present disclosure provides a method that includes one or more of: receiving, by a recruitment server, data related to an applicant for a position from the applicant's data provider node; parsing, by a recruitment server, the data using a skill filter to derive a plurality of matching features; providing the plurality of the matching features to a machine learning (ML) module; receiving a recommendation from the ML pertaining to interviewing the applicant; responsive to a receipt of a positive recommendation, accessing live interview data; deriving a feature vector from the live interview data; passing the feature vector to the ML module for generating a predictive model; and receiving predictive outputs from the ML module indicating a degree to which the applicant fits the position.

Another embodiment of the present disclosure provides a non-transitory computer readable medium comprising instructions, that when read by a processing component, cause the processing component to perform: receiving data related to an applicant for a position from the applicant's data provider node; parsing the data using a skill filter to derive a plurality of matching features; providing the plurality of the matching features to a machine learning (ML) module; receiving a recommendation from the ML module pertaining to interviewing the applicant; responsive to a receipt of a positive recommendation, accessing live interview data; deriving a feature vector from the live interview data; passing the feature vector to the ML module for generating a predictive model; and receiving predictive outputs from the ML module indicating a degree to which the applicant fits the position.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1A illustrates a network diagram of an automated system for an AI/ML-based processing of job applicants consistent with the present disclosure;

FIG. 1B illustrates a network diagram of an automated system for an AI/ML-based processing of job applicants including blockchain consistent with the present disclosure;

FIG. 2 illustrates a network diagram of a system including detailed features of a recruitment server node consistent with the present disclosure;

FIG. 3A illustrates a flow chart of a method for ML/AI-based processing of job applicants consistent with the present disclosure;

FIG. 3B illustrates a further flow chart of a method for ML/AI-based processing of job applicants consistent with the present disclosure;

FIG. 4 illustrates deployment of a machine learning model for prediction of applicant job fitting parameters using blockchain assets consistent with the present disclosure; and

FIG. 5 illustrates a block diagram of a system including a computing device for performing the method of FIGS. 3A and 3B.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of processing job applicants, embodiments of the present disclosure are not limited to use only in this context.

The present disclosure provides a system and method for an intelligent ML-based automated system for selection and AI-enhanced optimization of processing of job applicants. In one embodiment of the present disclosure, the system provides an “Apply-to-Interview” functionality—i.e., a candidate creates a dynamic profile directly related to a job position using a by-client-by-role-by-location criteria. The AI/ML-based automated system may use a customized Skill Filter for each job type/position based on an employment criterion provided by a potential employer. The Skill Filter may be generated by an ML module based on position and/or job requirements.

The AI/ML-based automated system may apply the Skill Filter to a matching criteria-pre-configured by the client (i.e., an employer). The system may apply the matching criteria to determine whether the candidate should be advanced to an interview process based on the match or based on a degree of matching or rating generated by the AI/ML module. Then, the AI/ML-based automated system may immediately offer to the applicant some interview times available based on pre-set days/times declared by a hiring manager. The AI/ML-based automated system may generate automated messaging (email and SMS) to inform and remind the candidates of their upcoming interview at increasing frequency as the interview time approaches. Once the interview time occurs, the candidate clicks a URL link uniquely created and matched to the correct interviewer. An interview session may be hosted by a team member who deals with any last-minute exceptions in order to facilitate a smooth process.

The system may allow the client (i.e., employer) to interview multiple candidates for the same time slot, as well as having multiple interviewers and subsequent interviews. The disclosed system may make visible to the interviewer all previously provided Skill Filter-based answers by category that may be retrieved from a secure storage such as a blockchain ledger. These answers may be conveniently visible to the interviewer on the same screen where the candidate interview takes place, with no switching tabs, or downloading additional software or applications, such as Zoom™. The system may have a configurable “Guided Interview” feature whereby the interviewer has a selection of pre-determined questions and “preferred” answers available to chart candidate responses as the interview progresses, to assess for “fit” during the live interview. In one embodiment of the present disclosure, the system may provide interview data along with the applicants' data to the ML module configured to provide employment recommendations based on outputs of a predictive model discussed in more detail below.

In one embodiment of the present disclosure, segment of the video of the interview is recorded or a live video feed data is provided to the AI/ML module. The system may parse the video data to produce a feature vector that may be processed by the AI/ML module. Once the interview is completed, the system may generate a summary which may include both the charted answers, any free text responses noted by the interviewer, as well as video snippets of “bookmarked” answers. This data may be stored on a blockchain along with the Skill Filter details as the Candidate Profile asset. The system may later retrieve the Candidate Profile and may use it to advance the candidate to follow up interviews, or as a basis for making an offer on the spot.

In one embodiment, the system may feed the Candidate Profile asset into the AI/ML module for optimal determination pertaining to further interview(s) or to immediate offer. The disclosed system may build a geo-specific record on blockchain ledger of all available candidates, who can be matched by the AI/ML module to other jobs across multiple local clients based on the matching criteria obtained by the Skill Filter regardless of whether the current candidate(s) matches to a target position at the time.

In one embodiment, the system may track the interactions of the candidate between applying for a job to showing up for the interview. This may include many factors, such as for example:
1. Email from a potential employee (or recruiter) having been opened by a candidate. These emails may be providing the additional information about the employment opportunity;
2. Tech check by the candidate to ensure that they are well prepared for the upcoming interview. For example, the candidate may check his or her computer configurations, audio/video settings, etc. In other words, the candidate showing additional interest in preparation for the interview; and
Evaluation of Skill Filter responses, indicating that the applicant has certain skill levels.

Each of the above factors may be assigned an initial weightage leveraged to calculate a candidate's score. As data is continuously collected from more and more candidate interviews, it will be used to train a machine learning model to determine the weightage for each factor that predicts the outcome of candidate job offer most accurately. The ML model may also segment and create unique weights for the factors by location, job position, wage rate, etc. attributes. This trained model may be used to provide more predictive scores to interviewers before the interview. These scores may also be used to determine priority interview slots to higher scoring candidates. These scores may also be used to determine if the hiring manager should be accompanying the interviewer for the interview to take the opportunity to give an instant offer.

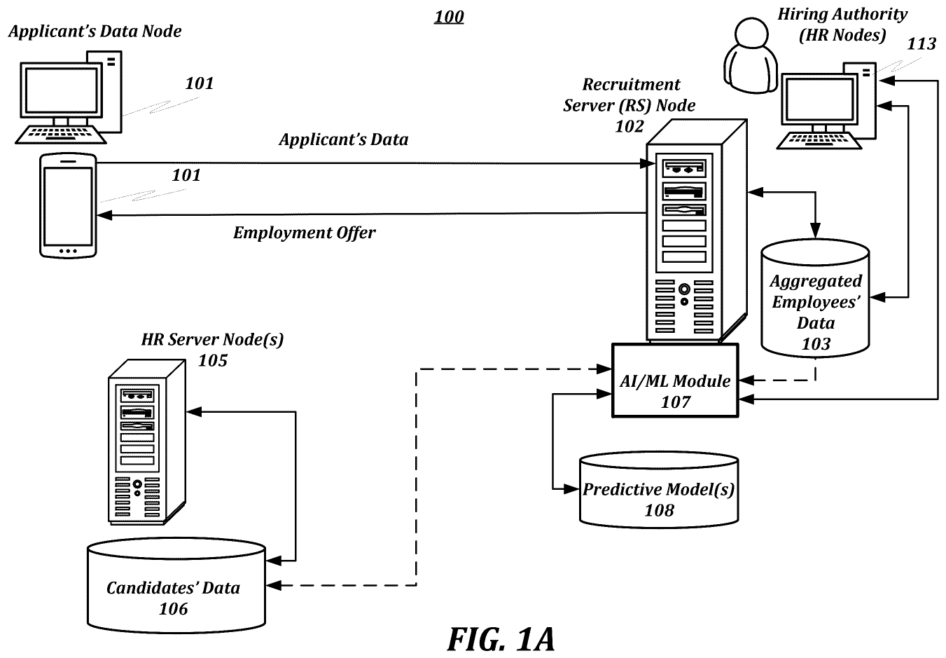

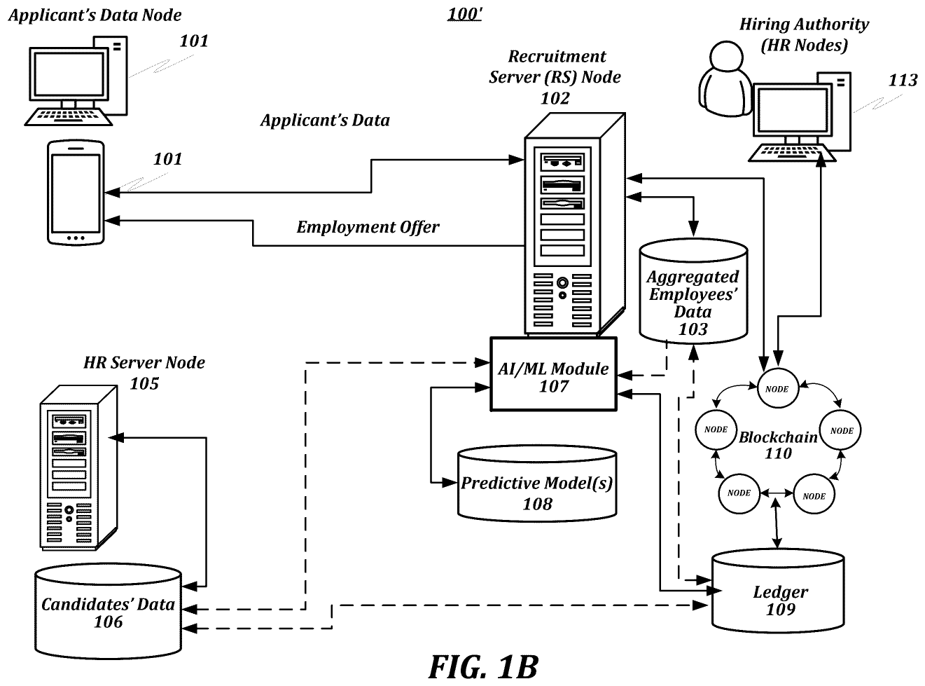

FIG. 1A illustrates a network diagram 100 of an automated system for an AI/ML-based processing of job applicants consistent with the present disclosure. As discussed above, a candidate applies for a job using his computer or mobile device—i.e., applicant's data provider node 101. A recruitment server (RS) node 102 may process candidate's data and may pass it on the AI/ML module 107 to be processed through the Skill Filter for a dynamic matching. The AI/ML-based processing may include the following features:
Skill Filter interaction tracking to optimize candidate experience;
Predictive usage analytics for continuous process refinement recommendation engine for better job match in a dynamic network;
Suggested up-skilling content to speed next match;
Automated messaging and response follow-ups to assess up-skill status progression;
Ability for candidate to record a follow-up interview video submission for assessment to advance to a next round.

As discussed above, the pre-interview process may include:
System-generated unique URL linked to each customized client job position and the Skill Filter;
Customizable by-job interview prep details and reminder timing to reduce no-shows;
Candidate scheduling analytics to optimize completed interviews and outcomes;
Device awareness at interview to make recommendations and avoid technical issues.

The interview process may include:
Skill Filter questions and Guided Interview Q&A branching logic to speed decision to offer;
Automated tracking to trigger notifications to interviewer for “candidate ready to interview”;
Pattern recognition modifies Guided Interview to increase success outcomes in real-time;
Interview session real-time candidate engagement and sentiment analysis;
Interview scoring in real time to confirm match;
Specific candidate answer video recording triggered to allow for “snippet” bookmarking and summary sharing for a later decision.

According to one embodiment of the present disclosure, the AI/ML module may perform any of the following functionalities:
Interview interaction statistics for anomalies reduction;
Predictive usage analytics for continuous process refinement;
Recommendation to initiate alternate job matches for subsequent interview at no offer suggested up-skilling content needed to speed up next match; and
Automated messaging follow-ups to assess up-skill status to progress.

The RS node 102 may provide the applicant's data to the AI/ML module 107 that may generate predictive model(s) 108 that may provide parameters for employment recommendation. The AI/ML module 107 may be implemented on the RS node 102 or on a cloud server (not shown). The AI/ML module may use local aggregated employees' data 103 for generating the predictive model(s) 108. The aggregated employees' data 103 may represent data of local employees who had been hired in the past for the same position or for a similar position or for a position within the same department, company, etc. In one embodiment, the RS node 102 may acquire candidates' data 106 from a remote HR server node(s) 105 belonging to other companies or recruitment outfits. The data 106 may be also ingested by the AI/ML module 107 for training and generation of accurate predictive model(s) 108.

In one embodiment, the AI/ML module 107 may receive interview answers data and interview video data from the RS node 102. This data may be used for generation of employment recommendation parameters. The RS node 102 may process the employment recommendation parameters to generate an employment verdict. Then, the verdict may be provided to the hiring authority via HR node(s) 113 for a final approval and generation of a job offer in case of a positive employment verdict. In one embodiment, the job offer may be automatically generated and sent to the applicant's data provider node 101. Other functionalities of the RS node 102 and the AI/ML module are discussed in more detail below.

FIG. 1B illustrates a network diagram 100′ of an automated system for an AI/ML-based processing of job applicants including blockchain consistent with the present disclosure.

As discussed above with respect to FIG. 1A, the RS node 102 may provide the applicant's data to the AI/ML module 107 that may generate predictive model(s) 108 that may provide parameters for employment recommendation. The AI/ML module 107 may be implemented on the RS node 102 or on a cloud server (not shown). The AI/ML module may use local aggregated employees' data 103 for generating the predictive model(s) 108. The aggregated employees' data 103 may represent data of employees who had been hired in the past for the same position or for a similar position or for a position within the same department, company, etc. In one embodiment, the RS node 102 may acquire candidates' data 106 from a remote HR server node(s) 105 belonging to other companies or recruitment outfits. This data may be also ingested by the AI/ML module 107 for training and generation of accurate predictive model(s) 108. The RS node 102, remote HR server node(s) 105 and the HR nodes 113 may serve as peers of a blockchain 110 network. In one embodiment, the applicant's data node(s) 101 may be onboarded the blockchain 110 prior to application processing. This may, advantageously, provide for a desired level of confidentiality and anonymity for the applicant.

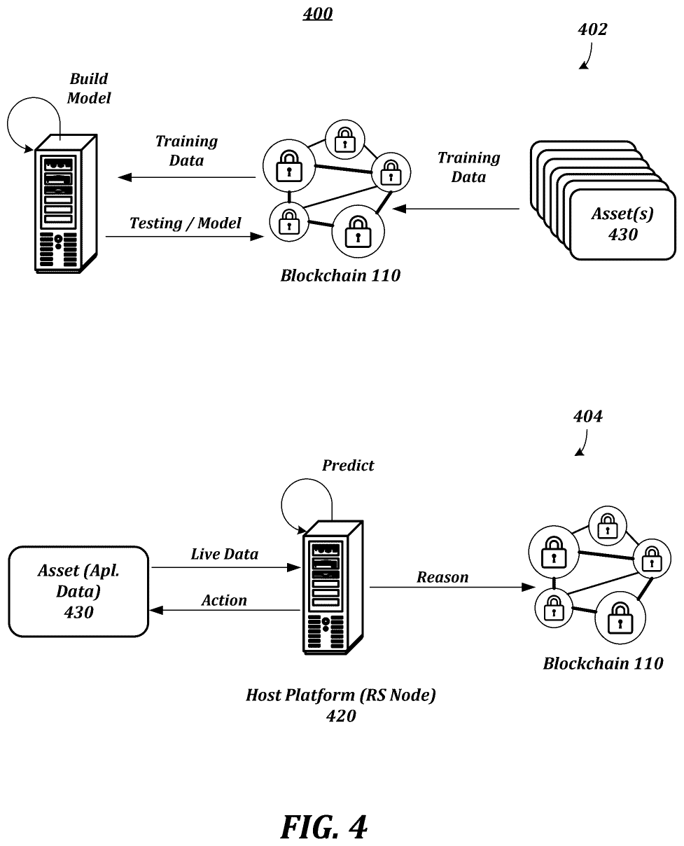

In one embodiment, the AI/ML module 107 may receive interview answers data and interview video data from the RS node 102. This data may be used for generation of employment recommendation parameters. The RS node 102 may process the employment recommendation parameters to generate an employment verdict. Then, the verdict may be provided to the hiring authority via HR node(s) 113 over the blockchain 110 for a final approval and generation of a job offer in case of a positive employment verdict. The HR nodes may provide a blockchain consensus for the employment verdict. Data 103 and 106 may be recorded on a ledger 109 of the blockchain 110 for training the AI/ML module 107 as discussed in detail below with reference to FIG. 4. In one embodiment, the employment offer may be recorded on the blockchain 110 along with the applicant's data for future training and for audit purposes. In one embodiment, the job offer may be automatically generated and sent to the applicant's data provider node 101 based on the blockchain consensus.

As discussed above, the RS node 102 may track the interactions of the candidate via the applicants' data node 101 during the time period between applying for a job to showing up for the interview. These interactions may include factors, such as for example:
Email(s) from a potential employee (or recruiter) having been opened by a candidate during this time period. These emails may be providing the additional information about the employment opportunity;
Tech check by the candidate to ensure that he or she is well prepared for the upcoming interview. For example, the candidate may check his or her computer configurations, internet connections, audio/video settings, etc. In other words, the candidate may be showing additional interest in preparation for the interview; and
Evaluation of Skill Filter responses, indicating that the applicant has certain skill levels. The RS node 102 may assign each of the above factors an initial weightage leveraged to calculate a candidate's score. As data is continuously collected from more and more candidate interviews, it will be used to train the predictive model 108 to determine the weightage for each factor that predicts the outcome of candidate job offer most accurately. The ML model may also segment and create unique weights for the factors by location, job position, wage rate, etc. attributes. This trained model may be used to provide more predictive scores to interviewers before the interview. These scores may also be used to determine priority interview slots to higher scoring candidates.

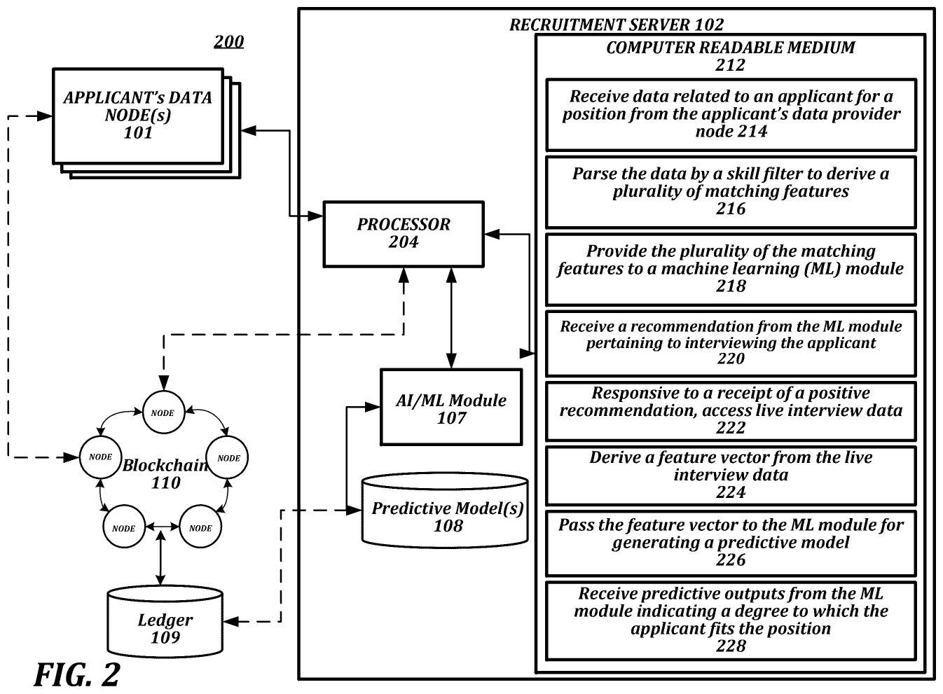

FIG. 2 illustrates a network diagram 200 of a system including detailed features of a recruitment server node consistent with the present disclosure.

Referring to FIG. 2, the example network 200 includes the recruitment server (RS) node 102 connected to applicant's data provider node(s) 101 over a network. In one embodiment, the RS node 102 may be connected to the applicant's data provider node(s) 101 over a blockchain 110 network. The RS node 102 and the applicant's data provider node(s) 101 may serve as blockchain 110 peers. Multiple other participant nodes (not shown) may be connected to the RS node 102. The RS node 102 may host or be operatively connected to an AI/ML module 107 configured to generated predictive models 108 based on data inputs received from the RS node 102. The AI/ML module 107 may run on a separate node (or on a cloud) or may be implemented on the RS 102 as shown in FIG. 2 and may be executed by the processor 204 of the RS node 102. The AI/ML module 107 may have access to a ledger 109 of the blockchain 110 for retrieval or storage of historical employment data that may be used as training data sets. The AI/ML module 107 may also use the data retrieved from the ledger 109 for generation of the predictive models 108 and for producing recommendations related to a recruitment process executed by the RS node 102.

While this example describes in detail only one the RS node 102, multiple such nodes may be connected to the blockchain 110 network. It should be understood that the RS node 102 may include additional components and that some of the components described herein may be removed and/or modified without departing from a scope of the RS node 102 disclosed herein. The RS node 102 may be a computing device or a server computer, or the like, and may include a processor 204, which may be a semiconductor-based microprocessor, a central processing unit (CPU), an application specific integrated circuit (ASIC), a field-programmable gate array (FPGA), and/or another hardware device. Although a single processor 204 is depicted, it should be understood that the RS node 102 may include multiple processors, multiple cores, or the like, without departing from the scope of the RS node 102 system.

The RS node 102 may also include a non-transitory computer readable medium 212 that may have stored thereon machine-readable instructions executable by the processor 204. Examples of the machine-readable instructions are shown as 214-228 and are further discussed below. Examples of the non-transitory computer readable medium 212 may include an electronic, magnetic, optical, or other physical storage device that contains or stores executable instructions. For example, the non-transitory computer readable medium 212 may be a Random-Access memory (RAM), an Electrically Erasable Programmable Read-Only Memory (EEPROM), a hard disk, an optical disc, or other type of storage device.

The processor 204 may fetch, decode, and execute the machine-readable instructions 214 to receive data related to an applicant for a position from the applicant's data provider node 101. The processor 204 may fetch, decode, and execute the machine-readable instructions 216 to parse the data by a skill filter to derive a plurality of matching features. The processor 204 may fetch, decode, and execute the machine-readable instructions 218 to provide the plurality of the matching features to a machine learning (ML) module. The processor 204 may fetch, decode, and execute the machine-readable instructions 220 to receive a recommendation from the ML module pertaining to interviewing an applicant. The processor 204 may fetch, decode, and execute the machine-readable instructions 222 to, responsive to a receipt of a positive recommendation, access live interview data. The processor 204 may fetch, decode, and execute the machine-readable instructions 224 to derive a feature vector from the live interview data. The processor 204 may fetch, decode, and execute the machine-readable instructions 226 to pass the feature vector to the ML module for generating a predictive model. The processor 204 may fetch, decode, and execute the machine-readable instructions 228 to receive predictive outputs from the ML module indicating a degree to which the applicant fits the position.

The blockchain 110 may be configured to use one or more smart contracts that manage transactions for multiple participating nodes (e.g., 101, 102, etc.).

In one embodiment, the instructions may further cause the processor to determine parameters and weights of the applicant's interview data including video stream data to be used in the predictive model 108. The instructions may further cause the processor 204 to, responsive to generation of recruitment data related to the current interview, record the applicants' data on the ledger 109 of the blockchain 110. The instructions may further cause the processor 204 to execute a smart contract to record the recruitment data on the blockchain 110.

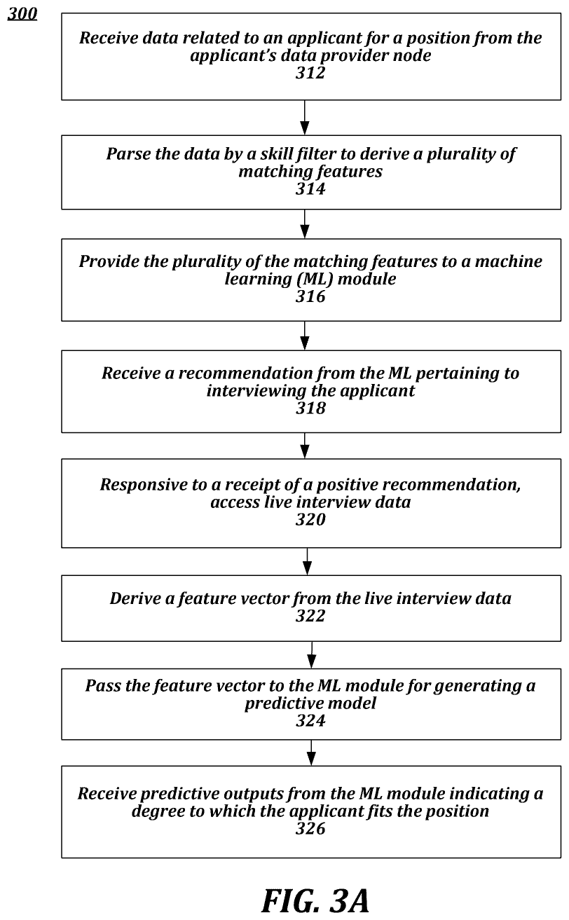

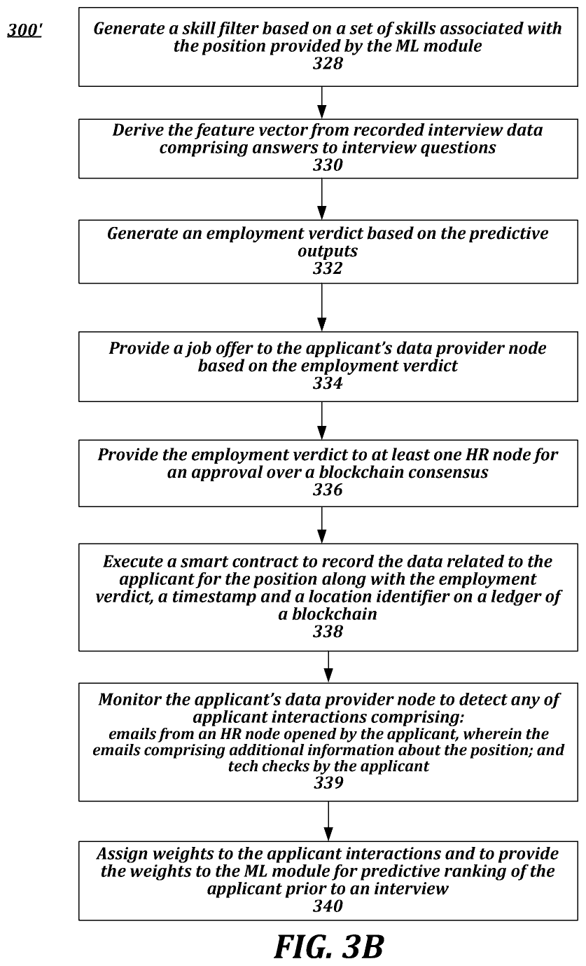

FIG. 3A illustrates a flow chart of a method for ML/AI-based processing of job applicants consistent with the present disclosure.

Referring to FIG. 3A, the method 300 may include one or more of the steps described below. FIG. 3A illustrates a flow chart of an example method executed by the RS node 102 (see FIG. 2). It should be understood that method 300 depicted in FIG. 3A may include additional operations and that some of the operations described therein may be removed and/or modified without departing from the scope of the method 300. The description of the method 300 is also made with reference to the features depicted in FIG. 2 for purposes of illustration. Particularly, the processor 204 of the RS node 102 may execute some or all of the operations included in the method 300.

With reference to FIG. 3A, at block 312, the processor 204 may receive data related to an applicant for a position from the applicant's data provider node. At block 314, the processor 204 may parse the data by a skill filter to derive a plurality of matching features. At block 316, the processor 204 may provide the plurality of the matching features to a machine learning (ML) module. At block 318, the processor 204 may receive a recommendation from the ML pertaining to interviewing an applicant. At block 320, the processor 204 may, responsive to a receipt of a positive recommendation, access live interview data. At block 322, the processor 204 may derive a feature vector from the live interview data. At block 324, the processor 204 may pass the feature vector to the ML module for generating a predictive model. At block 326, the processor 204 may receive predictive outputs from the ML module indicating a degree to which the applicant fits the position.

FIG. 3B illustrates a further flow chart of a method for ML/AI-based processing of job applicants consistent with the present disclosure.

Referring to FIG. 3B, the method 300′ may include one or more of the steps described below.

FIG. 3B illustrates a flow chart of an example method executed by the RS node 102 (see FIG. 2). It should be understood that method 300″ depicted in FIG. 3B may include additional operations and that some of the operations described therein may be removed and/or modified without departing from the scope of the method 300′. The description of the method 300′ is also made with reference to the features depicted in FIG. 2 for purposes of illustration. Particularly, the processor 204 of the recruitment server 102 may execute some or all of the operations included in the method 300′.

With reference to FIG. 3B, at block 328, the processor 204 may generate a skill filter based on a set of skills associated with the position provided by the ML module. At block 330, the processor 204 may derive the feature vector from recorded interview data comprising answers to interview questions. At block 332, the processor 204 may generate an employment verdict based on the predictive outputs. At block 334, the processor 204 may provide a job offer to the applicant's data provider node based on the employment verdict. At block 336, the processor 204 may provide the employment verdict to at least one HR node for an approval over a blockchain consensus.

At block 338, the processor 204 may execute a smart contract to record the data related to the applicant for the position along with the employment verdict, a timestamp and a location identifier on a ledger of a blockchain. At block 339, the processor 204 may monitor the applicant's data provider node to detect any of applicant interactions comprising: emails from an HR node opened by the applicant, wherein the emails comprising additional information about the position; and tech checks by the applicant. At block 340, the processor 204 may assign weights to the applicant interactions and may provide the weights to the ML module for predictive ranking of the applicant prior to an interview.

FIG. 4 illustrates deployment of a machine learning model for prediction of applicant job fitting parameters using blockchain assets consistent with the present disclosure. In one disclosed embodiment, the employment recommendation parameters' model may be generated by the AI/ML module 107 that may use training data sets to improve accuracy of the prediction of the employment recommendation parameters for the HR nodes 113 (FIGS. 1A and 1B). The employment parameters used in training data sets may be stored in a centralized local database (such as one used for storing aggregated employees' data 103 depicted in FIGS. 1A-1B). In one embodiment, a neural network may be used in the AI/ML module 107 for applicant employment modeling and updating employment recommendations.

In another embodiment, the AI/ML module 107 may use a decentralized storage such as a blockchain 110 (see FIG. 1B) that is a distributed storage system, which includes multiple nodes that communicate with each other. The decentralized storage includes an append-only immutable data structure resembling a distributed ledger capable of maintaining records between mutually untrusted parties. The untrusted parties are referred to herein as peers or peer nodes. Each peer maintains a copy of the parameter(s) records and no single peer can modify the records without a consensus being reached among the distributed peers. For example, the peers 113, 105 and 102 (FIG. 1B) may execute a consensus protocol to validate blockchain storage transactions, group the storage transactions into blocks, and build a hash chain over the blocks. This process forms the ledger by ordering the storage transactions, as is necessary, for consistency. In various embodiments, a permissioned and/or a permissionless blockchain can be used. In a public or permissionless blockchain, anyone can participate without a specific identity. Public blockchains can involve assets and use consensus based on various protocols such as Proof of Work (PoW). On the other hand, a permissioned blockchain provides secure interactions among a group of entities which share a common goal such as storing card usage recommendation parameters for efficient usage of the payment cards, but which do not fully trust one another.

This application utilizes a permissioned (private) blockchain that operates arbitrary, programmable logic, tailored to a decentralized storage scheme and referred to as “smart contracts” or “chaincodes.” In some cases, specialized chaincodes may exist for management functions and parameters which are referred to as system chaincodes. The application can further utilize smart contracts that are trusted distributed applications which leverage tamper-proof properties of the blockchain database and an underlying agreement between nodes, which is referred to as an endorsement or endorsement policy. Blockchain transactions associated with this application can be “endorsed” before being committed to the blockchain while transactions, which are not endorsed, are disregarded. An endorsement policy allows chaincodes to specify endorsers for a transaction in the form of a set of peer nodes that are necessary for endorsement. When a client sends the transaction to the peers specified in the endorsement policy, the transaction is executed to validate the transaction. After a validation, the transactions enter an ordering phase in which a consensus protocol is used to produce an ordered sequence of endorsed transactions grouped into blocks.

In the example depicted in FIG. 4, a host platform 420 (such as the RS node 102) builds and deploys a machine learning model for predictive monitoring of assets 430. Here, the host platform 420 may be a cloud platform, an industrial server, a web server, a personal computer, a user device, and the like. Assets 430 can represent employment recommendation parameters. The blockchain 110 can be used to significantly improve both a training process 402 of the machine learning model and the employment parameters' predictive process 405 based on a trained machine learning model. For example, in 402, rather than requiring a data scientist/engineer or other user to collect the data, historical data (heuristics—i.e., previous hiring or employment-related data) may be stored by the assets 430 themselves (or through an intermediary, not shown) on the blockchain 110.

This can significantly reduce the collection time needed by the host platform 420 when performing predictive model training. For example, using smart contracts, data can be directly and reliably transferred straight from its place of origin (e.g., from the applicant's data provider node 101 or from HR server node 105) to the blockchain 110. By using the blockchain 110 to ensure the security and ownership of the collected data, smart contracts may directly send the data from the assets to the entities that use the data for building a machine learning model. This allows for sharing of data among the assets 430. The collected data may be stored in the blockchain 110 based on a consensus mechanism. The consensus mechanism pulls in (permissioned nodes such as nodes 102, 105 and 113) to ensure that the data being recorded is verified and accurate. The data recorded is time-stamped, cryptographically signed, and immutable. It is therefore auditable, transparent, and secure.

Furthermore, training of the machine learning model on the collected data may take rounds of refinement and testing by the host platform 420. Each round may be based on additional data or data that was not previously considered to help expand the knowledge of the machine learning model. In 402, the different training and testing steps (and the data associated therewith) may be stored on the blockchain 110 by the host platform 420. Each refinement of the machine learning model (e.g., changes in variables, weights, etc.) may be stored on the blockchain 110. This provides verifiable proof of how the model was trained and what data was used to train the model. Furthermore, when the host platform 420 has achieved a finally trained model, the resulting model itself may be stored on the blockchain 110.

After the model has been trained, it may be deployed to a live environment where it can make optimal employment recommendations/predictions based on the execution of the final trained machine learning model using the employment parameters. In this example, data fed back from the asset 430 may be input into the machine learning model and may be used to make event predictions such as most optimal employment parameters for generation of employment recommendation to the user (e.g., HR nodes 113). Determinations made by the execution of the machine learning model (e.g., employment parameters, etc.) at the host platform 420 may be stored on the blockchain 110 to provide auditable/verifiable proof. As one non-limiting example, the machine learning model may predict a future change of a part of the asset 430 (the employment parameters). The data behind this decision may be stored by the host platform 420 on the blockchain 110.

As discussed above, in one embodiment, the features and/or the actions described and/or depicted herein can occur on or with respect to the blockchain 110. The above embodiments of the present disclosure may be implemented in hardware, in a computer-readable instructions executed by a processor, in firmware, or in a combination of the above. The computer computer-readable instructions may be embodied on a computer-readable medium, such as a storage medium. For example, the computer computer-readable instructions may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

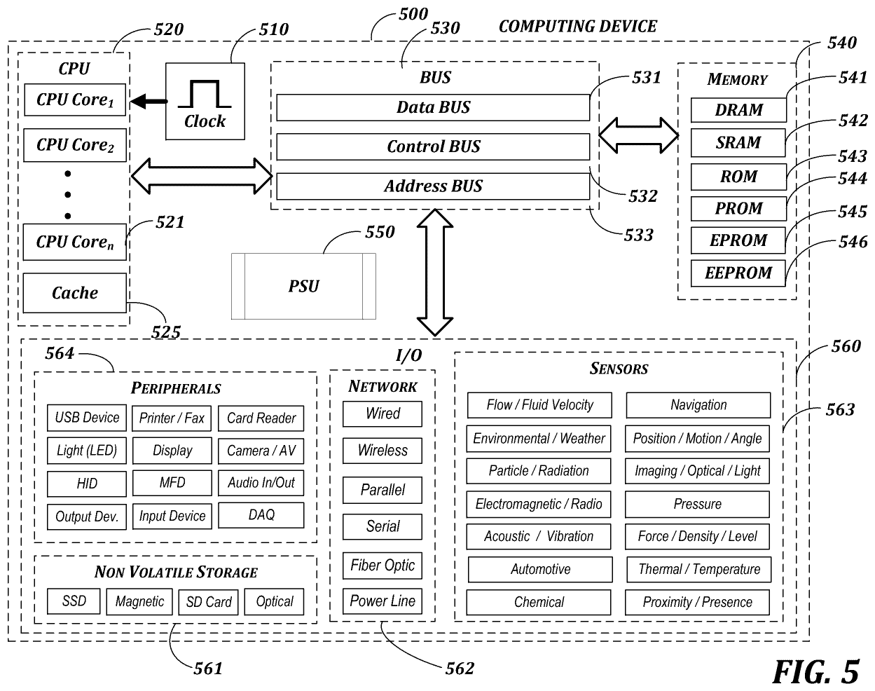

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative embodiment, the processor and the storage medium may reside as discrete components. For example, FIG. 5 illustrates an example computing device (e.g., a server node) 500, which may represent or be integrated in any of the above-described components, etc.

The computing device 500 may comprise, but not be limited to the following:

Mobile computing device, such as, but is not limited to, a laptop, a tablet, a smartphone, a drone, a wearable, an embedded device, a handheld device, an Arduino, an industrial device, or a remotely operable recording device;

A supercomputer, an exa-scale supercomputer, a mainframe, or a quantum computer;

A minicomputer, wherein the minicomputer computing device comprises, but is not limited to, an IBM AS500/iSeries/System I, A DEC VAX/PDP, a HP3000, a Honeywell-Bull DPS, a Texas Instruments TI-990, or a Wang Laboratories VS Series;

A microcomputer, wherein the microcomputer computing device comprises, but is not limited to, a server, wherein a server may be rack mounted, a workstation, an industrial device, a raspberry pi, a desktop, or an embedded device;

The recruitment server 102 (see FIG. 2) may be hosted on a centralized server or on a cloud computing service. Although method 300 has been described to be performed by the recruitment server 102 implemented on a computing device 500, it should be understood that, in some embodiments, different operations may be performed by a plurality of the computing devices 500 in operative communication at least one network.

Embodiments of the present disclosure may comprise a computing device having a central processing unit (CPU) 520, a bus 530, a memory unit 550, a power supply unit (PSU) 550, and one or more Input/Output (I/O) units. The CPU 520 coupled to the memory unit 550 and the plurality of I/O units 560 via the bus 530, all of which are powered by the PSU 550. It should be understood that, in some embodiments, each disclosed unit may actually be a plurality of such units for the purposes of redundancy, high availability, and/or performance. The combination of the presently disclosed units is configured to perform the stages any method disclosed herein.

Consistent with an embodiment of the disclosure, the aforementioned CPU 520, the bus 530, the memory unit 550, a PSU 550, and the plurality of I/O units 560 may be implemented in a computing device, such as computing device 500. Any suitable combination of hardware, software, or firmware may be used to implement the aforementioned units. For example, the CPU 520, the bus 530, and the memory unit 550 may be implemented with computing device 500 or any of other computing devices 500, in combination with computing device 500. The aforementioned system, device, and components are examples and other systems, devices, and components may comprise the aforementioned CPU 520, the bus 530, the memory unit 550, consistent with embodiments of the disclosure.

At least one computing device 500 may be embodied as any of the computing elements illustrated in all of the attached figures, including the recruitment server 102 (FIG. 2). A computing device 500 does not need to be electronic, nor even have a CPU 520, nor bus 530, nor memory unit 550. The definition of the computing device 500 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 500, especially if the processing is purposeful.

With reference to FIG. 5, a system consistent with an embodiment of the disclosure may include a computing device, such as computing device 500. In a basic configuration, computing device 500 may include at least one clock module 510, at least one CPU 520, at least one bus 530, and at least one memory unit 550, at least one PSU 550, and at least one I/0 560 module, wherein I/O module may be comprised of, but not limited to a non-volatile storage sub-module 561, a communication sub-module 562, a sensors sub-module 563, and a peripherals sub-module 565.

Consistent with an embodiment of the disclosure, the computing device 500 may include the clock module 510 known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 520, the central component of modern computers, which relies on a clock. The only exceptions are asynchronous circuits such as asynchronous CPUs. The clock 510 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 5 wires.

Many computing devices 500 use a “clock multiplier” which multiplies a lower frequency external clock to the appropriate clock rate of the CPU 520. This allows the CPU 520 to operate at a much higher frequency than the rest of the computer, which affords performance gains in situations where the CPU 520 does not need to wait on an external factor (like memory 550 or input/output 560). Some embodiments of the clock 510 may include dynamic frequency change, where, the time between clock edges can vary widely from one edge to the next and back again.

A system consistent with an embodiment of the disclosure the computing device 500 may include the CPU unit 520 comprising at least one CPU Core 521. A plurality of CPU cores 521 may comprise identical CPU cores 521, such as, but not limited to, homogeneous multi-core systems. It is also possible for the plurality of CPU cores 521 to comprise different CPU cores 521, such as, but not limited to, heterogeneous multi-core systems, big.LITTLE systems and some AMD accelerated processing units (APU). The CPU unit 520 reads and executes program instructions which may be used across many application domains, for example, but not limited to, general purpose computing, embedded computing, network computing, digital signal processing (DSP), and graphics processing (GPU). The CPU unit 520 may run multiple instructions on separate CPU cores 521 at the same time. The CPU unit 520 may be integrated into at least one of a single integrated circuit die and multiple dies in a single chip package. The single integrated circuit die and multiple dies in a single chip package may contain a plurality of other aspects of the computing device 500, for example, but not limited to, the clock 510, the CPU 520, the bus 530, the memory 550, and I/0 560.

The CPU unit 520 may contain cache 522 such as, but not limited to, a level 1 cache, level 2 cache, level 3 cache or combination thereof. The aforementioned cache 522 may or may not be shared amongst a plurality of CPU cores 521. The cache 522 sharing comprises at least one of message passing and inter-core communication methods may be used for the at least one CPU Core 521 to communicate with the cache 522. The inter-core communication methods may comprise, but not limited to, bus, ring, two-dimensional mesh, and crossbar. The aforementioned CPU unit 520 may employ symmetric multiprocessing (SMP) design.

The plurality of the aforementioned CPU cores 521 may comprise soft microprocessor cores on a single field programmable gate array (FPGA), such as semiconductor intellectual property cores (IP Core). The plurality of CPU cores 521 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 521, for example, but not limited to Instruction-level parallelism (ILP) such as, but not limited to, superscalar pipelining, and Thread-level parallelism (TLP).

Consistent with the embodiments of the present disclosure, the aforementioned computing device 500 may employ a communication system that transfers data between components inside the aforementioned computing device 500, and/or the plurality of computing devices 500. The aforementioned communication system will be known to a person having ordinary skill in the art as a bus 530. The bus 530 may embody internal and/or external plurality of hardware and software components, for example, but not limited to a wire, optical fiber, communication protocols, and any physical arrangement that provides the same logical function as a parallel electrical bus. The bus 530 may comprise at least one of, but not limited to a parallel bus, wherein the parallel bus carry data words in parallel on multiple wires, and a serial bus, wherein the serial bus carry data in bit-serial form. The bus 530 may embody a plurality of topologies, for example, but not limited to, a multidrop/electrical parallel topology, a daisy chain topology, and a connected by switched hubs, such as USB bus. The bus 530 may comprise a plurality of embodiments, for example, but not limited to:
Internal data bus (data bus) 531/Memory bus
Control bus 532
Address bus 533
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/ Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect extended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCle (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/105 bus (e.g., PC/105-Plus, PCI/105-Express, PCI/105, and PCI-105), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1395 Interface/Firewire, Thunderbolt, and extensible Host Controller Interface (xHCI).

Consistent with the embodiments of the present disclosure, the aforementioned computing device 500 may employ hardware integrated circuits that store information for immediate use in the computing device 500, know to the person having ordinary skill in the art as primary storage or memory 550. The memory 550 operates at high speed, distinguishing it from the non-volatile storage sub-module 561, which may be referred to as secondary or tertiary storage, which provides slow-to-access information but offers higher capacities at lower cost. The contents contained in memory 550, may be transferred to secondary storage via techniques such as, but not limited to, virtual memory and swap. The memory 550 may be associated with addressable semiconductor memory, such as integrated circuits consisting of silicon-based transistors, used for example as primary storage but also other purposes in the computing device 500. The memory 550 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 551, Static Random-Access Memory (SRAM) 552, CPU Cache memory 525, Advanced Random-Access Memory (A-RAM), and other types of primary storage such as Random-Access Memory (RAM).
Non-volatile memory which can retain stored information even after power is removed, for example, but not limited to, Read-Only Memory (ROM) 553, Programmable ROM (PROM) 555, Erasable PROM (EPROM) 555, Electrically Erasable PROM (EEPROM) 556 (e.g., flash memory and Electrically Alterable PROM [EAPROM]), Mask ROM (MROM), One Time Programable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 500 may employ the communication system between an information processing system, such as the computing device 500, and the outside world, for example, but not limited to, human, environment, and another computing device 500. The aforementioned communication system will be known to a person having ordinary skill in the art as I/0 560. The I/O module 560 regulates a plurality of inputs and outputs with regard to the computing device 500, wherein the inputs are a plurality of signals and data received by the computing device 500, and the outputs are the plurality of signals and data sent from the computing device 500. The I/O module 560 interfaces a plurality of hardware, such as, but not limited to, non-volatile storage 561, communication devices 562, sensors 563, and peripherals 565. The plurality of hardware is used by the at least one of, but not limited to, human, environment, and another computing device 500 to communicate with the present computing device 500. The I/O module 560 may comprise a plurality of forms, for example, but not limited to channel I/O, port mapped I/0, asynchronous I/0, and Direct Memory Access (DMA).

Consistent with the embodiments of the present disclosure, the aforementioned computing device 500 may employ the non-volatile storage sub-module 561, which may be referred to by a person having ordinary skill in the art as one of secondary storage, external memory, tertiary storage, off-line storage, and auxiliary storage. The non-volatile storage sub-module 561 may not be accessed directly by the CPU 520 without using intermediate area in the memory 550. The non-volatile storage sub-module 561 does not lose data when power is removed and may be two orders of magnitude less costly than storage used in memory module, at the expense of speed and latency. The non-volatile storage sub-module 561 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (561) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD+RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 500 may employ the communication sub-module 562 as a subset of the I/O 560, which may be referred to by a person having ordinary skill in the art as at least one of, but not limited to, computer network, data network, and network. The network allows computing devices 500 to exchange data using connections, which may be known to a person having ordinary skill in the art as data links, between network nodes. The nodes comprise network computer devices 500 that originate, route, and terminate data. The nodes are identified by network addresses and can include a plurality of hosts consistent with the embodiments of a computing device 500. The aforementioned embodiments include, but not limited to personal computers, phones, servers, drones, and networking devices such as, but not limited to, hubs, switches, routers, modems, and firewalls.

Two nodes can be said are networked together, when one computing device 500 is able to exchange information with the other computing device 500, whether or not they have a direct connection with each other. The communication sub-module 562 supports a plurality of applications and services, such as, but not limited to World Wide Web (WWW), digital video and audio, shared use of application and storage computing devices 500, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 5 [IPv5], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 562 may comprise a plurality of size, topology, traffic control mechanism and organizational intent. The communication sub-module 562 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,5G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 500 may employ the sensors sub-module 563 as a subset of the I/O 560. The sensors sub-module 563 comprises at least one of the devices, modules, and subsystems whose purpose is to detect events or changes in its environment and send the information to the computing device 500. Sensors are sensitive to the measured property, are not sensitive to any property not measured, but may be encountered in its application, and do not significantly influence the measured property. The sensors sub-module 563 may comprise a plurality of digital devices and analog devices, wherein if an analog device is used, an Analog to Digital (A-to-D) converter must be employed to interface the said device with the computing device 500. The sensors may be subject to a plurality of deviations that limit sensor accuracy. The sensors sub-module 563 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 500 may employ the peripherals sub-module 562 as a subset of the I/O 560. The peripheral sub-module 565 comprises ancillary devices uses to put information into and get information out of the computing device 500. There are 3 categories of devices comprising the peripheral sub-module 565, which exist based on their relationship with the computing device 500, input devices, output devices, and input/output devices. Input devices send at least one of data and instructions to the computing device 500. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 500. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 565:
Input Devices
   Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 500. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device, in order to capture produced sound. Audio input devices allow a user to send audio signals to the computing device 500 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 500. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers and plotters.
   Audio and Video (AV) devices, such as, but not limited to, speakers, headphones, amplifiers and lights, which include lamps, strobes, DJ lighting, stage lighting, architectural lighting, special effect lighting, and lasers.
   Other devices such as Digital to Analog Converter (DAC).
Input/Output Devices may further comprise, but not be limited to, touchscreens, networking device (e.g., devices disclosed in network 562 sub-module), data storage device (non-volatile storage 561), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A system, comprising:
a processor of a recruitment server connected to at least one applicant data provider node over a network; and
a memory on which are stored machine-readable instructions that when executed by the processor, cause the processor to:
receive data related to an applicant for a position from the applicant's data provider node,
parse the data by a skill filter to derive a plurality of matching features,
provide the plurality of the matching features to a machine learning (ML) module,
receive a recommendation from the ML module pertaining to interviewing the applicant,
responsive to a receipt of a positive recommendation, access live interview data,
derive a feature vector from the live interview data,
pass the feature vector to the ML module for generating a predictive model, and
receive predictive outputs from the ML module indicating a degree to which the applicant fits the position.

2. The system of claim 1, wherein the instructions further cause the processor to generate a skill filter based on a set of skills associated with the position provided by the ML module.

3. The system of claim 1, wherein the instructions further cause the processor to derive the feature vector from recorded interview data comprising answers to interview questions.

4. The system of claim 1, wherein the instructions further cause the processor to generate an employment verdict based on the predictive outputs.

5. The system of claim 4, wherein the instructions further cause the processor to provide a job offer to the applicant's data provider node based on the employment verdict.

6. The system of claim 4, wherein the instructions further cause the processor to provide the employment verdict to at least one HR node for an approval over a blockchain consensus.

7. The system of claim 4, wherein the instructions further cause the processor to execute a smart contract to record the data related to the applicant for the position along with the employment verdict, a timestamp and a location identifier on a ledger of a blockchain.

8. The system of claim 1, wherein the instructions further cause the processor to monitor the applicant's data provider node to detect any of applicant interactions comprising:
emails from an HR node opened by the applicant, wherein the emails comprising additional information about the position; and
tech checks by the applicant.

9. The system of claim 1, wherein the instructions further cause the processor to assign weights to interactions by the applicant and to provide the weights to the ML module for predictive ranking of the applicant prior to an interview.

10. A method, comprising:
receiving, by a recruitment server (RS) node, data related to an applicant for a position from a data provider node associated with the applicant;
parsing, by the RS node, the data using a skill filter to derive a plurality of matching features;
providing, by the RS node, the plurality of the matching features to a machine learning (ML) module;
receiving, by the RS node, a recommendation from the ML module pertaining to interviewing the applicant;
responsive to a receipt of a positive recommendation, accessing, by the RS node, live interview data;
deriving, by the RS node, a feature vector from the live interview data;
passing, by the RS node, the feature vector to the ML module for generating a predictive model; and
receiving, by the RS node, predictive outputs from the ML module indicating a degree to which the applicant fits the position.

11. The method of claim 10 further comprising, generating a skill filter based on a set of skills associated with the position provided by the ML module.

12. The method of claim 10 further comprising, deriving the feature vector from recorded interview data comprising answers to interview questions.

13. The method of claim 10 further comprising, generating an employment verdict based on the predictive outputs.

14. The method of claim 13 further comprising, providing a job offer to the applicant's data provider node based on a positive employment verdict.

15. The method of claim 13 further comprising, providing the employment verdict to at least one HR node for an approval over a blockchain consensus.

16. The method of claim 13 further comprising, executing a smart contract to record the data related to the applicant for the position along with the employment verdict, a timestamp and a location identifier on a ledger of a blockchain.

17. A non-transitory computer readable medium comprising instructions, that when read by a processing component, cause the processing component to perform:
receiving data related to an applicant for a position from a data provider node associated with the applicant;
parsing the data using a skill filter to derive a plurality of matching features;
providing the plurality of the matching features to a machine learning (ML) module;
receiving a recommendation from the ML module pertaining to interviewing the applicant;
responsive to a receipt of a positive recommendation, accessing live interview data;
deriving a feature vector from the live interview data;
passing the feature vector to the ML module for generating a predictive model; and
receiving predictive outputs from the ML module indicating a degree to which the applicant fits the position.

18. The non-transitory computer readable medium of claim 17, further comprising instructions, that when read by the processing component, cause the processing component to generate a skill filter based on a set of skills associated with the position provided by the ML module.

19. The non-transitory computer readable medium of claim 17, further comprising instructions, that when read by the processing component, cause the processing component to derive the feature vector from recorded interview data comprising answers to interview questions.

20. The non-transitory computer readable medium of claim 17, further comprising instructions, that when read by the processing component, cause the processing component to generate an employment verdict based on the predictive outputs.
